(19) United States
(12) Patent Application Publication
(10) Pub. No.: US 2009/0053000 A1
(43) Pub. Date: Feb. 26, 2009

(54) Compact High Precision Multiple Spindle Computer Controlled Machine Tool

(76) Inventors: Steven S. Miyano, Barrington Hills, IL (US); Thomas T. Miyano, Barrington Hills, IL (US)

Correspondence Address: FRANCISSEN PATENT LAW, P.C., 53 W. JACKSON BLVD, SUITE # 1320, CHICAGO, IL, 60604, US

(21) Appl. No.: 12/295,809

(22) PCT Filed: Apr. 9, 2007
(86) PCT No.: PCT/US2007/066261

§ 371 Date: Oct. 2, 2008

Related U.S. Application Data
(60) Provisional application No. 60/790,071, filed on Apr. 7, 2006.

(51) Int. Cl. B23B 39/00

(52) U.S. Cl. 408/55

(57) ABSTRACT

A compact, multiple spindle computer-controlled machine tool is disclosed. The machine may have a spindle base with two spindles disposed vertically relative to one another along an axis, the spindles having parallel axes of rotation. The spindle base may be computer controlled and have z and x axis motion relative to a tool post. The tool post may have a tool turret and may provide computer-controlled y axis motion so that the tool turret may be utilized with both spindles. The tool post may also have a machining unit that may be used to machine workpieces held by either spindle.

### FIELD OF THE INVENTION

This invention pertains to machine tools and, more particularly, to machine tools that utilize spindles to hold a workpiece.

### BACKGROUND OF THE INVENTION

FIG. 1 is a side view illustrating one example of a conventional computer numerically controlled (CNC) lathe 10. In this example, the CNC lathe 10 has one main spindle 20 with a chuck 22 for mounting and rotating in a z axis a workpiece. The main spindle is attached to the spindle head. Note: A chuck is a “hand”, grabbing the workpiece used when a cutting processed, usually for a lathe and a machining center (computer controlled milling machine). Lathe 10 also includes a turret 30 that revolves to process the necessary cutting tools or cutlery for cutting the workpiece mounted to chuck 22. Note: A turret is a rotational base in which a metal cutting tool can be attached. Turret 30 is mounted on a processing base 32 that, in this example, is able to move along an X axis and a Z axis in order to engage the workpiece being held by chuck 22 and rotated by spindle 20 mounted in spindle head 20A. FIG. 2 is a simplified end view of lathe 10 illustrating a relationship between spindle 20, which is fixed in this example, and turret 30, which can move in the x axis to engage the workpiece held by chuck 22. In this example, lathe 10 includes a tail stock 42 that prevents a run off from the revolving center concentric to the direction of the main spindle when cutting a long cylindrical workpiece accurately, which is mounted in the z axis. The spindle 20, turret 30 and Turret Head 32, and tail stock 42 are mounted on a machine body 40.

Usually, a workpiece requires machining on both a front surface and a back surface. FIGS. 3A-C illustrate, respectively, a left (front) end view, a side view, and a right (back) end view of an example of a workpiece. Because of the structure, a general CNC-Lathe can only work on one side, front or back of a workpiece at one time. Typically, a chuck, such as chuck 22 in FIG. 1, must grip and hold the face of the workpiece. Because the different faces of the workpiece often have different configurations, different gripping mechanisms are required to grip the workpiece. As a result, different CNC lathe machines are often used to work the two different surfaces of the workpiece. Moving a workpiece from one machine to another requires either a human worker to transfer the workpiece between machines or relatively complex automatic moving and conveying equipment.

In order to eliminate the need for human labor of complex moving equipment, one conventional approach, demonstrated in the CNC lathe 100 of FIG. 4, is to provide a secondary spindle 150 that is disposed on the same machine base 140 as the main spindle 120 and turret 130. The secondary spindle 150, in this example, is positioned on machine body 140 concentric with main spindle 120 along the z axis and facing main spindle 120. Secondary spindle 150 is configured to move along the z axis so that it can get hold of a workpiece that has been initially cut using main spindle 120. The second chuck 152 is configured to engage the workpiece after it has been cut using the main spindle. For example, the gripping fingers of chuck 152 are configured to engage the right end view of the workpiece of FIG. 3C. The secondary main spindle then begins to revolve and turret 130 proceeds to work the other surface of the workpiece, e.g. to obtain the left end view of FIG. 3A. The resulting lathe 100 is able to work both faces of a workpiece and requires reduced human or moving equipment interaction, but it is also quite large and takes up a significant amount of factory floor space.

Another approach to machining both end surfaces of a workpiece is to provide a lathe machine that has two spindles on one machine body positioned parallel to one another so that they face the same direction, such as the example lathe 200 shown in FIGS. 5 and 6. Lathe 200 has a main spindle 220 that interacts with turret 230, which is mounted on a turret head or tool post 232 that is capable of motion in the x axis and y axis. Likewise, a secondary spindle 250 interacts with turret 260, which is mounted on a turret head 262 that is also capable of motion in the x axis and y axis. Turret Head 232 and 262 are mounted on machine body 240. However, the resulting machine tool 200 requires either human labor for moving the workpiece or complex automated moving equipment.

FIGS. 7A-7F illustrate an example of the moving equipment that may be required to move a workpiece to, from and between the spindles 220 and 250 of lathe 200. Typically, a first conveyor belt 300 transports a workpiece to machine tool 200 for processing. A hand 312 is mounted on axle 310, which, in this example, rotates and moves longitudinally parallel to spindles 220 and 250 in order to grip a workpiece from conveyor 300 and move it into place for handoff to hand 322 mounted on axle 320. Axle 320 rotates and moves longitudinally in order to move and engage the workpiece with chuck 222. Spindle 220 begins to rotate and turret 230 works the piece under computer control. After the workpiece is worked by turret 230, hand 322 grips the workpiece and moves it to a reversing hand (not shown) for reversing the faces of the workpiece. Then hand 332 mounted on axle 330 moves in to grip the reversed workpiece to move and engage it with chuck 252 of spindle 250. Spindle 250 begins to rotate and turret 260 works the other face of the workpiece under computer control. Hand 332 then moves in to remove the finished workpiece to conveyor 302 for removal.

Note that this is a simplified diagram and each of the hands 312, 322 and 332 will likely require multiple hands for gripping the workpiece before and after it has been worked by turrets 230 and 260. Typically, each axle or arm would be fitted with two hands—one hand configured for the shape of the workpiece face before it is machined and another hand configured for the shape of the workpiece face after it is machined. The hand units are typically expansive or contractive grippers that require significant power in order to firmly grip the workpiece. The power grippers require a controlled source of force to drive the grippers as needed. Further, the axles shown will typically require control motors that can generate significant amounts of torque and complex sensory control in order to accurately move the workpiece. This may require an additional function for computer controller, such as a CNC controller, for operating the moving equipment, such as a robot arm and hand, in addition to the one used to control the bases for the turrets or other equipment of the machine tool. Also, a reversing hand, in this example, may require significant power levels and complex sensing to grip and reverse the work piece accurately. Further, the conveyors, arms and hands typically require very precise adjustment by a technician.

In addition, note that the side-by-side spindles of machine tool 200 shown in FIGS. 5-7 typically must be operated one at a time in order to achieve high precision. Otherwise, the vibration from one spindle can affect the precision of the machining operation performed on the other spindle. Some applications address this problem by mechanically decoupling the two spindles by splitting the machine body 240 and providing a vibration barrier, such as a rubber bushing, between the two halves of the machine body.

### BRIEF SUMMARY OF THE INVENTION

In one embodiment, a compact high precision multiple spindle computer-controlled machine tool is provided having a spindle head with two spindles disposed vertically relative to one another along a y axis with parallel axes of rotation. The spindle base has computer controlled z and x axis motion relative to a turret head or tool post. The tool post has a tool turret and provides computer-controlled y axis motion so that the tool turret may be utilized with both spindles. In another embodiment, the tool post is also provided with a machining unit that may be used to machine workpieces held by either spindle. In still another embodiment, the tool post is provided with a rotating gripper unit having multiple hands, where the gripper unit is able to engage workpieces from either spindle and move workpieces between the two spindles as well as to and from moving equipment serving the machine tool. This hand is controlled along the Y axis with the tool post at the same time. In another embodiment, the tool post is able to move the gripping hand using the same y axis motion in order to engage the gripping unit with a reversing hand for reversing a workpiece. The tool post has a device that consists of several hands to transport the workpiece from the two main spindles. In still another embodiment, the spindle base is provided with computer controlled b axis rotational so that angled machine cuts may be performed. Alternatively, the tool post is provided with computer controlled b axis rotation. In one embodiment, the spindle base includes a motor that drives both spindles. In another embodiment, each spindle has a built in motor.

### BRIEF DESCRIPTION OF THE DRAWINGS

FIG. 1 is a side view illustrating one example of a conventional computer numerical controlled (CNC) lathe.

FIG. 2 is a simplified end view of the lathe of FIG. 1 illustrating a relationship between a spindle, which is fixed in this example, and turret, which can move in the x-axis to engage the workpiece held by a chuck.

FIGS. 3A-C illustrate, respectively, a left (front) end view, a side view, and a right (back) end view of an example of a workpiece.

FIG. 4 is a side view illustrating an example of a conventional CNC lathe having two spindles on same machine bases, where the spindles have the same rotational axis.

FIGS. 5 and 6 are front and top views, respectively, illustrating an example of a conventional CNC lathe having two spindles in a side by side configuration along with two turrets.

FIGS. 7A-F illustrate an example of the workpiece moving equipment that may be required for the machine tool of FIGS. 5 and 6.

FIGS. 8-10F illustrate one example of a compact high precision and multiple spindles with computer controlled machine tool having a spindle head with two parallel spindles disposed one over the other. It means, spindles disposed parallel setting with vertical.

FIGS. 11-13 show another example of a compact high precision machine where a single turret or tool unit is mounted on a tool post or machine base that has y axis motion in addition to x and z axis movement.

FIGS. 14-16 shows the machine tool of FIGS. 11-13 modified to include a milling unit attached to the same head as the turret.

FIGS. 17-19 show another example of a compact high precision machine that includes a milling unit attached to the same head as a turret along with divide rotating movement multiple hand gripper unit that is also mounted to the head.

FIGS. 20 and 21 are simplified top views illustrating some of the machining angles B axis movement that can be obtained using the capabilities of the milling machine of FIGS. 17-19.

FIG. 22 is a front view of an example of a spindle base that includes a thermal probe port Figure 626 for inserting a thermal probe.

FIGS. 23 through 31 illustrate the operation of one embodiment of a machine tool.

FIGS. 32 through 35 illustrate an embodiment of a machine tool that includes a spindle base having computer controlled b axis rotational movement.

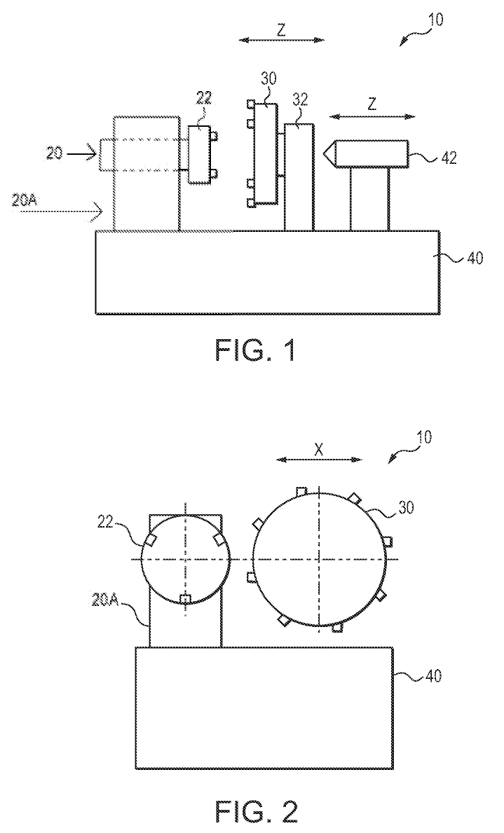

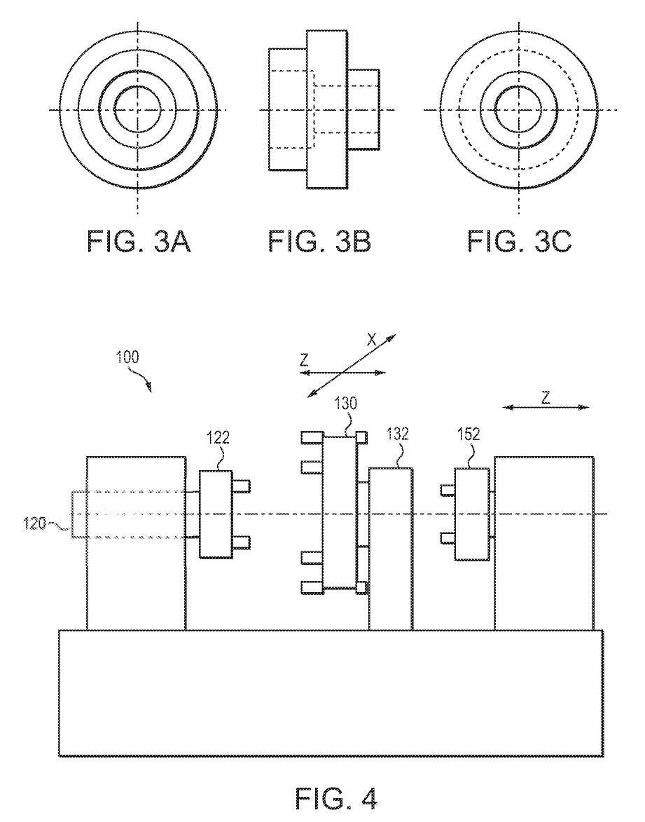

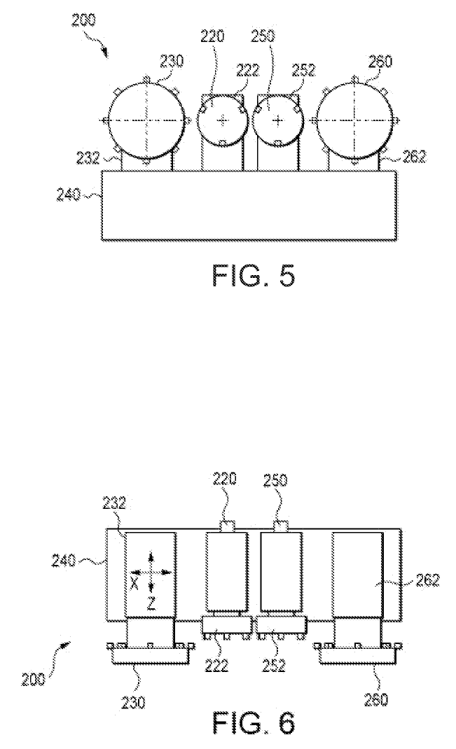

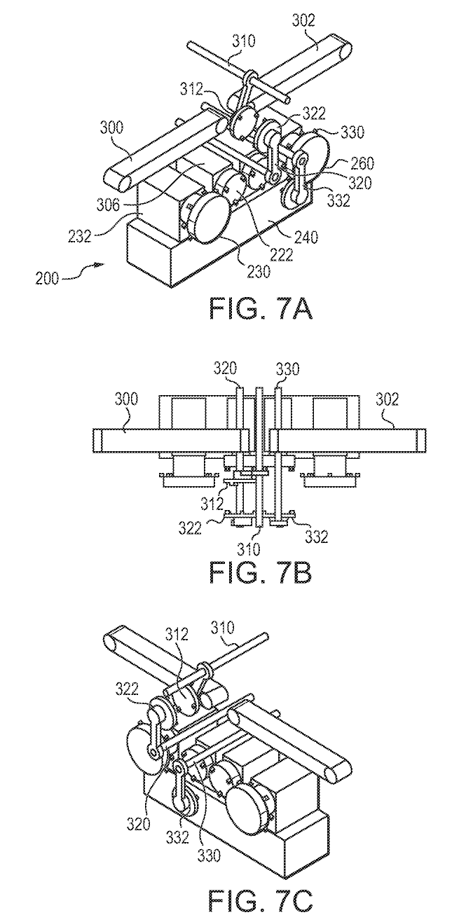

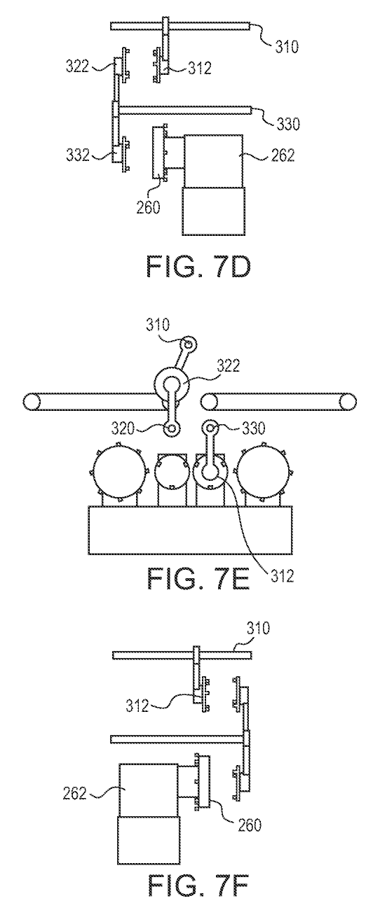

### DETAILED DESCRIPTION OF THE INVENTION

The present invention is directed to a compact high-precision, multiple spindles with computer controlled machine tool. In some embodiments, the invention provides computer numerical control (CNC) lathe capabilities. Other embodiments provide for machining center functionality. The invention generally involves the use of a spindle head having two spindles with parallel rotational axes.

The following examples further illustrate the invention but should not be construed in any way as limiting its scope.

### Example 1

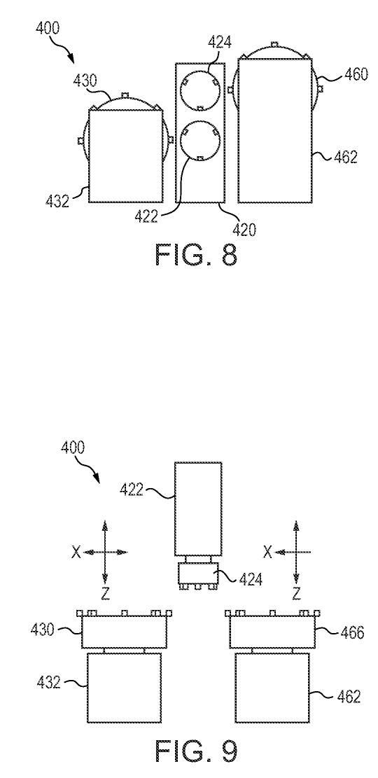

FIGS. 8-10 illustrate one example of a compact high-precision multiple spindle computer controlled machine tool 400. In this example, one spindle body 420 is equipped with two spindles 422 and 424 along with their associated chucks. Spindles 422 and 424 have substantially parallel rotational axes. Spindle body 420, in this example, is a fixed position device. A first turret 430 is mounted on a turret head or tool post 432, which has x and z axis movement, as indicated in FIG. 9. Note that a tool post is a mounting base for the turret head and other machine devices. Examples for “other machine devices” are milling unit, laser processing device, etc. A second turret 460 is mounted on base 462, which also has x and z axis movement. Turret 430 is aligned with the lower spindle 422 (as illustrated in FIG. 8) and is able to move in the x axis to engage a cutting tool with a workpiece. Base 432 is able to move in the z axis in order to work the length of the workpiece. Turret 460 is aligned with the upper spindle 424 ( as illustrated in FIG. 8) and is able to move in the x axis to engage a cutting tool with a workpiece. Base 462 is able to move in the z axis in order to work the length of the workpiece.

The over and under configuration of spindles 422 and 424 on spindle head 420 results in machine 400 being more compact relative to the conventional solutions discussed above. Also, the vertical orientation of spindles 422 and 424 permits the workpiece moving equipment to be simplified. The moving equipment generally moves in the z axis parallel to the axes of spindles 422 and 424 and a y axis. For example, tool posts or turret heads 432 and 462 may be moved apart along the x axis and a conveyor moved along the z axis to introduce or remove a workpiece. Similarly, robotic arms with movement in the z axis and the y axis may be used to move the workpiece to and from conveyor belts and between the spindles 422 and 424. Also note that while spindles 422 and 424 could each be constructed with a coaxial motor for driving the respective spindle, the present configuration permits one motor to be provided in base 420 and used to drive both spindles 422 and 424. Also, the lower spindle may be configured to be a heavier duty spindle than the upper spindle. Note that tool posts 432 and 462, as well as spindle body 420, are typically securely mounted to a machine base.

### Example 2

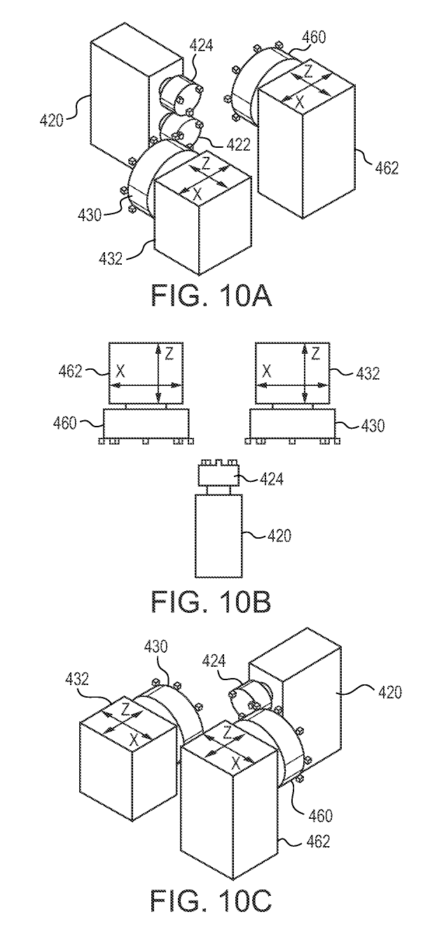

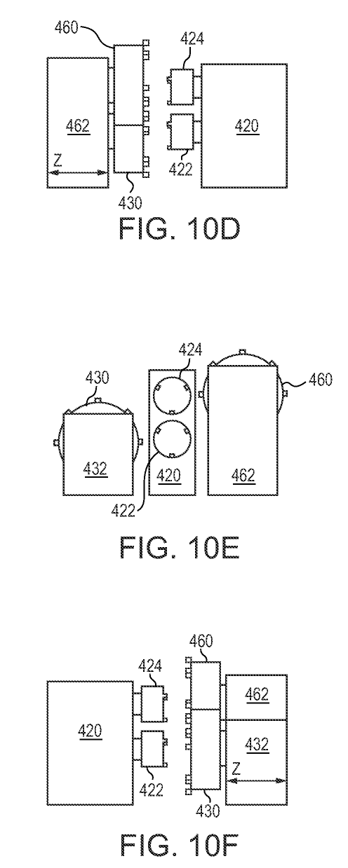

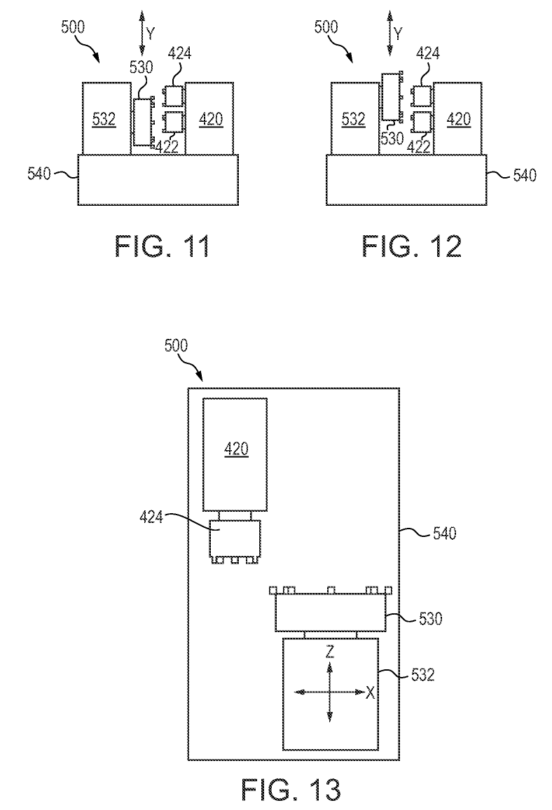

FIGS. 11-13 show another example of a compact high precision machine 500. In this embodiment, one turret 530 is mounted on a tool post 532 that provides for y axis motion in addition, in this embodiment, to x and z axis movement through a computer controlled movable coupling to machine base 540. The y axis motion permits turret 530 to be used to machine a workpiece (not shown) held by either spindle 422 or 424. Spindle head 420 is also mounted on machine base 540. FIG. 10 is a side view that illustrates turret 530 positioned on the same level as spindle 422 for working a first face of a workpiece when it is clamped in a chuck of spindle 422. FIG. 11 is a side view that illustrates turret 530 positioned on the same level as spindle 424 for working a second face of the workpiece when it is clamped in a chuck of spindle 424. FIG. 12 is a top view that illustrates the highly compact layout of machine 500, which has a tool post 532 that provides x, y and z axis motion.

### Example 3

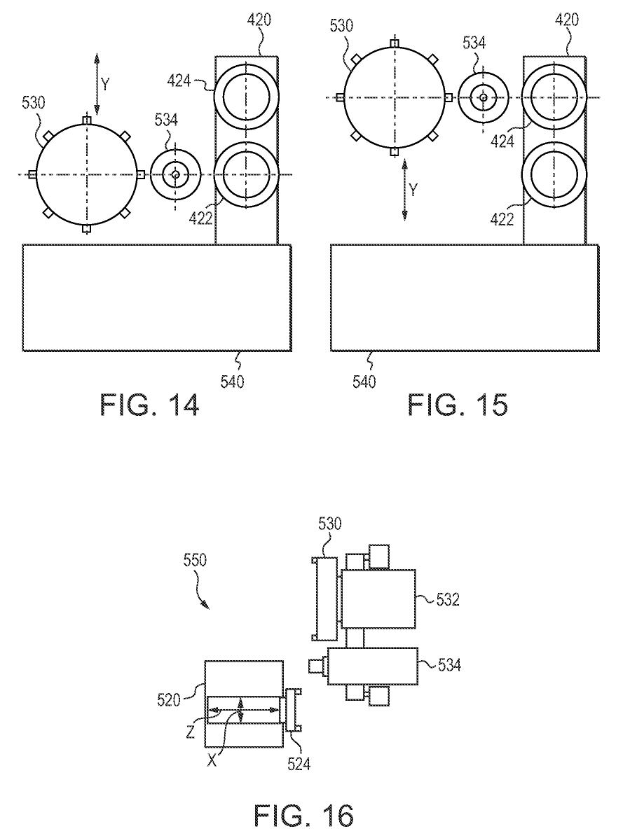

FIGS. 14-16 show the machine 500 of FIGS. 11-13 modified to include a milling unit 534 attached to the same tool post 532 as turret 530. Because tool post 532 is able to move in the x and y axes, milling unit 534 may be included in order to mill the face surfaces of a workpiece held by chucks on spindles 422 and 424 and rotated on the spindles, which results in the machine operating as a machining center. FIG. 14 is a side view showing turret 530 and milling unit 534 in position along the y axis for working on a workpiece held by spindle 422. FIG. 15 is a side view showing turret 530 and milling unit 534 in position along the y axis for working on a workpiece held by spindle 424. The y axis movement provided in tool post 532 permits the turret 530 and milling unit 534 to be used on both spindles 422 and 424, while the x axis movement of post 532 permits both turret 530 and milling unit 534 to be used to work the piece.

The milling unit permits the machine 500 to perform a wider variety of processing on a workpiece using the same computer controlled axes as for turret 530. Thus, machine 500 offers a compact high precision machine tool with enhanced capability at reduced cost.

Note that one of the spindles 422 and 424 may be dedicated for performing milling cutting. A milling cutting exclusive spindle may permit more variation of processing and can work as a more powerful milling cutter than a tool-post with just a revolving tool unit or turret.

### Example 4

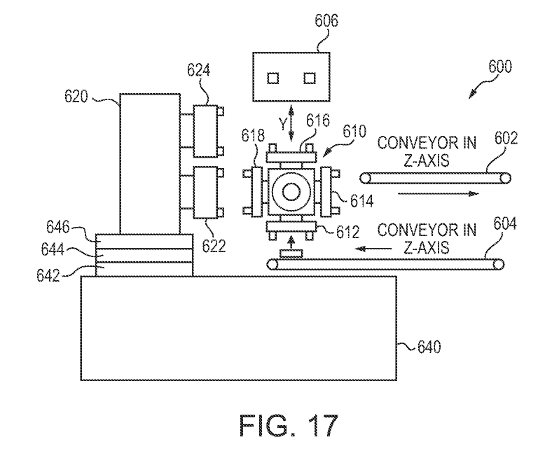

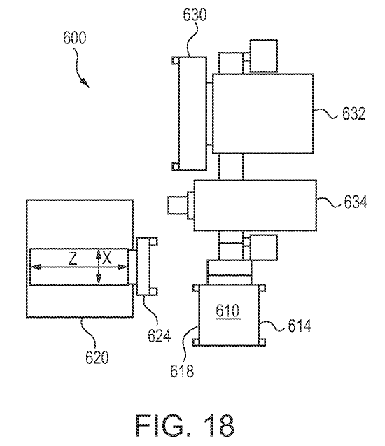

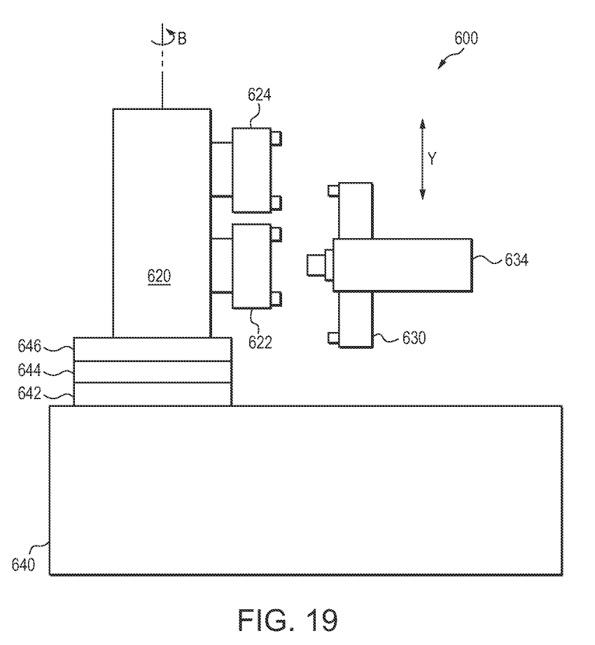

FIGS. 17-19 show another example of a compact high precision machine 600 that includes a milling unit 634 attached to the same tool post 632 as turret 630 along with a rotating multiple hand gripper unit 610 that is also mounted to tool post 632. FIG. 17 is a side view of machine 600 that illustrates rotational gripper unit 610, which is mounted on tool post 632, relative to spindle head 620, reversal hand unit 606 and conveyors 602 and 604. FIG. 18 is a top view illustrating turret 630, milling unit 634 and gripper unit 610 mounted on tool post 632 with respect to spindle head 620, which is illustrated with x and z axis motion. FIG. 19 is a cutaway side view illustrating milling unit 634 and turret 630, which are mounted on tool post 632, which provides for y axis motion.

Spindle head 620 includes first and second spindles 622 and 624 and is mounted to machine base 640 through plates 642, 644 and 646 that provide for x, z and b axis motion, respectively. In this example, tool post 632 provides for y axis motion that permits the turret 630, milling unit 634 and hand unit 610 to be moved up and down with respect to spindles 622 and 624, e.g. between the rotational axes of the spindles. Note that tool post 632 could be mounted to machine base 640 through computer controlled motion plates similar to plates 642, 644 and 646 to provide x, z and b axis motion in an alternative embodiment.

The gripper unit 610 has rotational movement and four hand grippers 612, 614, 616 and 618 for securely gripping a workpiece at different stages of machining. Note that a hand, such as the hand units of gripper unit 610, the chucks of spindles 622 and 624, and the reversal hand 606, is typically configured to engage, e.g. through a combination of compressive and expansive forces, a specific surface configuration of a workpiece. Thus, at the various stages of machining, a different hand configuration is typically required to engage the first and second surfaces of the workpiece before and after machining.

An example of the operation of milling machine 600 will now be described. An initially unworked workpiece is conveyed by conveyor belt 604, which has z axis movement in this example, to move the workpiece into position below gripper unit 610. Conveyor 604 may be provided with a relief spring to allow for the gripper unit 610 to apply pressure to the conveyor and obtain a more secure grip on a workpiece. A relief switch may be provided in the conveyor to indicate to the computer controller when the conveyor is compressed and confirm engagement of the hand of the gripper unit with the workpiece, which allows the hand to be a simplified device that does not require sensors. Also, the hand unit may utilize spring loaded gripping devices, which are simpler and more reliable than pressure driven gripping devices. Also, while conventional gripper units typically have only two hand units, rotational gripper unit 610 may be configured with four different hand units that provide for gripping a workpiece in four different ways, which permits the machine tool to perform more processing without human intervention or additional moving equipment. Gripper unit 610 may also be pneumatically powered.

Gripper unit 610 rotates so that hand unit 612 is oriented downward toward the workpiece on conveyor 604. Tool post 632 moves gripper unit 610 downward along a y axis so that hand 612 of gripper unit 610 engages the workpiece on conveyor 604. Because tool post 632 is moving gripper unit 610 downward towards conveyor 604, hand unit 612 can utilize spring loaded fingers or pneumatic cylinder control fingers to securely grip the workpiece.

Tool post 632 moves upward along the y axis, thereby capable of lifting the workpiece to a level in line with spindle 622. Gripper unit 610 rotates so that hand unit 612 faces the chuck of spindle 622, permitting the workpiece may be engaged by the chuck. Spindle head 620 moves along the z axis to cause the chuck of spindle 622 to engage the workpiece held by hand unit 612. When spindle head 620 leaves this position to return to the initial cutting position, of course chuck of spindle 622 or 624 grips the workpiece. Computer controlled chuck 622 begins to rotate, movement of spindle head 620 and movement of tool post 632 which locates turret 630 and milling unit 634 in order to machine a first surface. When machining on the first surface of the workpiece is complete, gripper unit 610 rotates hand unit 614 toward the workpiece being held by the chuck of spindle 622. Just as hand unit 612 was configured to engage and grip the unmachined first surface of the workpiece and the chuck of spindle 622 was configured to engage and grip an unmachined second surface of the workpiece, hand unit 614 is configured to engage and grip the machined first surface of the workpiece.

Spindle head 620 moves along the z axis to cause the machine first surface of the workpiece with hand unit 614. The chuck 622 releases the workpiece and spindle head 620 moves away from hand unit 614 along the z axis. Gripper unit 610 rotates so that hand unit 614 is oriented upward facing reversal hand unit 606. Tool post 632 moves gripper unit 610 upward along the y axis so that reversal hand unit 606 can engage the workpiece held by hand unit 614. Tool post 632 then moves gripper unit 610 downward along the y axis so that reversal hand 606 can rotate in order to reverse the surfaces of the workpiece. Gripper unit 610 rotates so that hand unit 616, which is configured to engage the unmachined second surface of the workpiece, faces reversal hand unit 606 and tool post 632 moves gripper unit 610 upward along the y axis so that hand unit 616 engages the workpiece held by reversal hand unit 606. Note that this configuration of the reversal hand unit 606 and gripper unit 610 exploits the role of gravity in engaging the workpiece with the hand unit 616.

Tool post 632 then moves gripper unit 610 downward along the y axis to a position adjacent spindle 624. Gripper unit 610 rotates so that hand unit 616 faces the chuck of spindle 624, which is configured to engage the machined first surface of the workpiece. Spindle head 620 then moves along the z axis so that the chuck of spindle 624 engages and grips the workpiece. Spindle head 620 then moves away from gripper unit 610 and begins to rotate. The controller can coordinate the movement of spindle 624, turret 630 and milling unit 634 in order to machine the second surface of the workpiece. When machining of the second surface of the workpiece is complete, gripper unit 610 rotates so that hand unit 618, which is configured to engage and grip the machined second surface of the workpiece, faces the chuck of spindle 624. Spindle head 620 then moves along the z axis so that the workpiece engages hand unit 618, which grips the workpiece. Spindle head 620 then withdraws along the z axis and tool post 632 moves upward along the y axis to permit conveyor 602 to move in along a z axis to a position below gripper unit 610. Gripper unit 610 rotates so that hand unit 618 faces conveyor 602, moves downward along the y axis to place the completed workpiece on conveyor 602, hand unit 618 releases the workpiece, and tool post 632 raises gripper unit 610 upward away from conveyor 602 so that the conveyor can move the complete workpiece away from milling machine 600 without interference.

Note that the milling machine 600 of this example provides for precision milling along five axes: the x, z and b axes of spindle head 620, and spindle rotation movement called the c-axis, the axis of either spindle 622 or 624, and the y axis of tool post 632. Also note that the milling machine may be reconfigured so that the different axes are provided by different units. For example, the b, z and x axes may be provided, instead, by the tool post 632. One of ordinary skill in the art will readily recognize that specific embodiments may be configured in a variety of ways without departing from the spirit of the present invention.

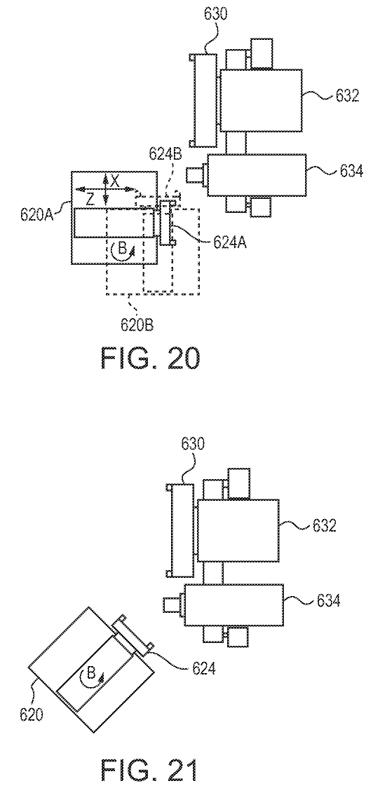

FIGS. 20 and 21 are simplified top views illustrating some of the machining angles that can be obtained using the capabilities of milling machine 600 described above with respect to FIGS. 17-19. FIG. 20 illustrates spindle head 620 rotated from a first position (e.g. spindle head 620A and spindle 624A) to a second position (spindle head 620B and spindle 624B) on the b axis of the spindle head. This position permits machining unit 634 to cut a workpiece at a 90° or other angle. Similarly, other cutting angles can be achieved. FIG. 21 illustrates an example where spindle head 620 is rotated to a 45° angle for cutting. The high degree of precision and multiple axes of machine tool 600 allow it to be used to produce a wide variety of high precision products, such as medical implants.

Note that the machine of FIGS. 20 and 21 may provide for 360° rotation about the b axis along with sliding motion in the x and y axes. As a result, the machine tool may be used to perform a milling cut from a large range of angles. Also, because the workpiece can be removed, reversed and engaged by the second spindle, both surfaces of the workpiece can be mill cut from a large range of angles. With a workpiece that is generally concentric from the two opposing surface directions as a result of being lathe worked, combined with the b-axis control for making mill cuts at a large range of angles, the result is that many workpieces may be processed completely using the machine tool.

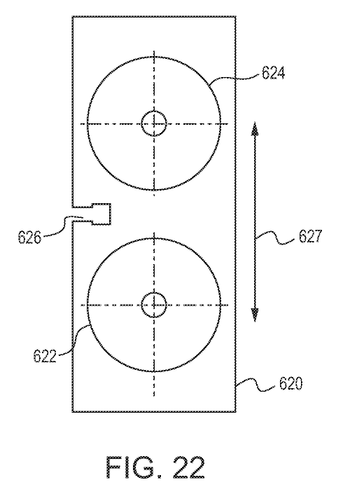

FIG. 22 is a front view of an example of spindle head 620 that includes a thermal probe port 626 for inserting a thermal probe. Spindle head 620 will typically heat up during operation resulting in thermal expansion, for example along the line 627, which can introduce inaccuracies in the machining process. The heating, and consequential thermal expansion, will likely vary during processing. There may be additional heating in a spindle base that includes two spindles. A thermal probe is used by the controller to track the heat of the spindle head and compensate for thermal expansion in order to maintain the precision of the machining process. Typically, the controller adjusts and corrects for expansion along the y axis of the tool post 632.

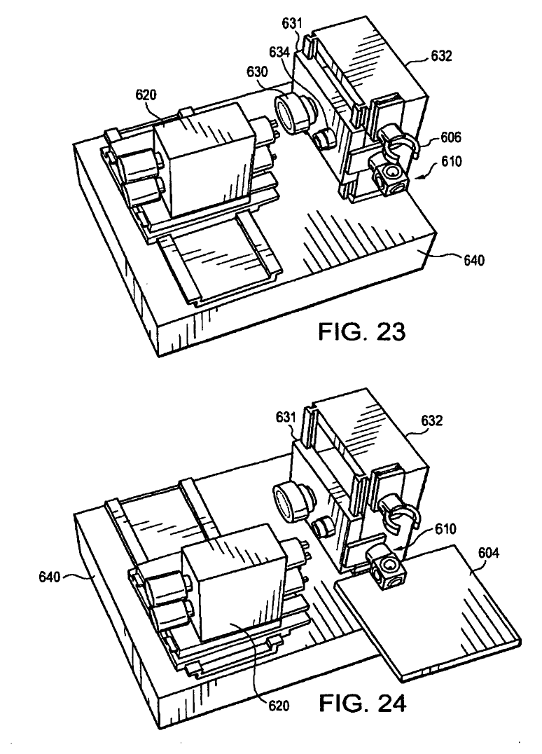

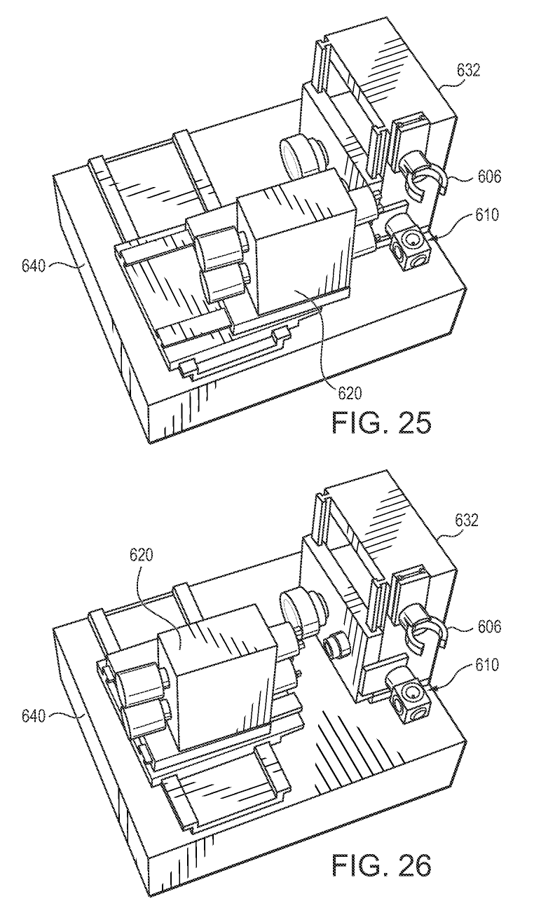

FIGS. 23 through 31 further illustrate the operation of one embodiment of a machine tool. FIG. 23 is a perspective view of a machine tool having a spindle head 620 with two spindles oriented vertically with respect to machine base 640 in parallel, where the spindle head 620 is coupled to machine base 640 through plates that provide computer controlled x and z axis motion, such as through plates 642 and 644 shown in FIG. 19. A tool post 632 is shown that has a turret unit 630 for lathing operations, a milling unit 634 for machining operations, and a four hand rotating gripper unit 610 mounted together on a computer controlled y axis motion plate 631 mounted to tool post 632. A rotating reversing hand 606 is provided that is mounted to the tool post 632 with a fixed position. In FIG. 24, the spindle head 620 is moved away from the tool post 632 and a conveyor 604 with z axis motion relative to the tool post 632 and spindle head 620 moves in below the rotational gripper unit 610 in order to move an unprocessed workpiece (not shown) into position below the gripper unit 610. The y motion plate 631 mounted to tool post 632 moves along the y axis so that a first hand of the gripper unit 610 can engage the unprocessed workpiece on the conveyor 604. The y motion plate 631 then moves the gripper unit 610 upward along the y axis to a position parallel with the lower spindle of the spindle body 620. The conveyor 604 is withdrawn and the spindle body 620 moves itself along the x axis such that the lower spindle is aligned with the gripper unit 610, which has rotated the workpiece to face the lower spindle. The spindle head 620 then moves along the z axis such that the lower spindle can engage the unprocessed workpiece held by the first hand of the gripper unit 610, as shown in FIG. 25.

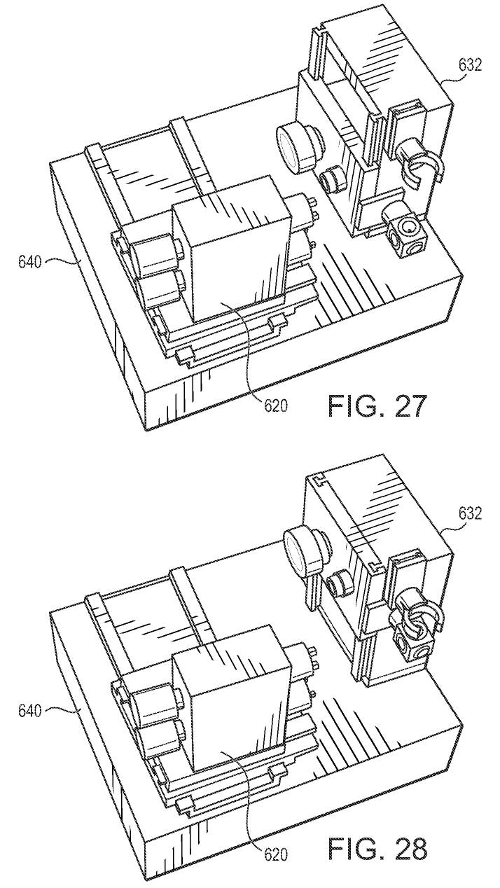

The chuck of the lower spindle engages the unprocessed workpiece and the spindle head 620 withdraws along the z axis and moves toward the turret unit or milling unit along the x axis, as shown in FIG. 26, so that the unprocessed workpiece may be subjected to a lathing process by the turret unit 630 or a machining process by the milling unit to produce a workpiece with a first machined surface. The spindle head 620 then moves along the x and z axis to orient the lower spindle with the gripper unit 610, as shown in FIG. 27, and the gripper unit 610 rotates so that a second hand faces the workpiece with a first machined surface. Similar to the orientation shown in FIG. 25, the spindle head 620 moves along the z axis so that the second hand of the gripper unit 610 engages and grips the first machined surface of the workpiece. The spindle head 620 then withdraws along the z axis and the gripper unit 610 rotates so that the workpiece faces the fixed position reversing hand 606. The y motion plate 631 moves the gripper unit 610 along the y axis so that the workpiece engages the reversing hand 606, as shown in FIG. 28. The y motion plate 631 mounted to tool post 632 then lowers the gripper unit 610 and the reversing hand 606 rotates to reverse the workpiece so that an unfinished second surface of the workpiece faces the gripper unit 610. The gripper unit 610 rotates so that a third hand that is configured to engage the unfinished second surface of the workpiece faces the reversing hand 606. The y motion plate 631 raises the gripper unit 610 to engage the workpiece and the reversing hand 606 releases the workpiece. Because the third hand of the gripper unit 610 is below the workpiece, gravitational force, rather than electromagnetic or pneumatic force, is used to securely engage the workpiece with the third hand.

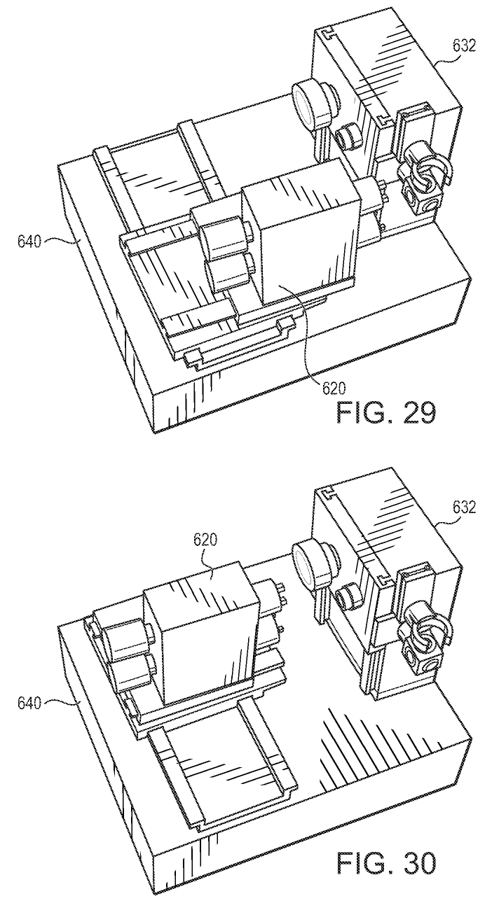

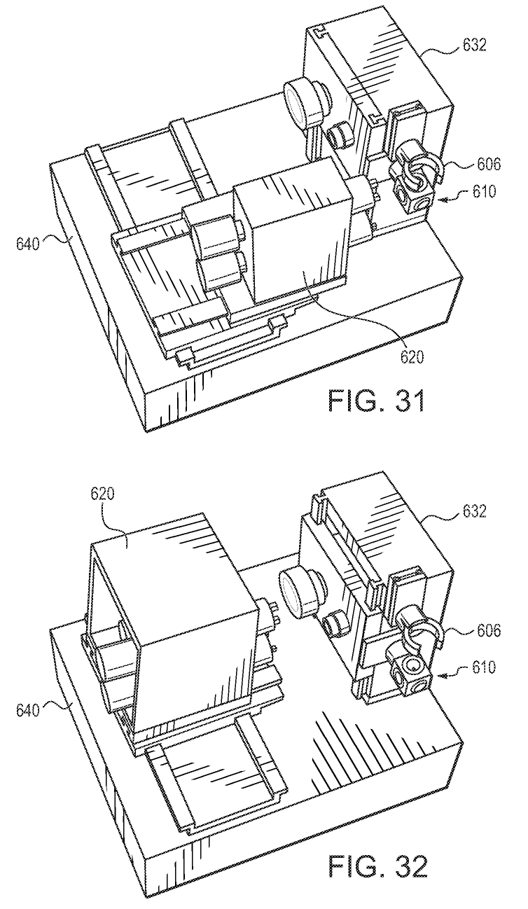

The y motion plate 631 mounted to tool post 632 then lowers the gripper unit 610 to a position aligned with the upper spindle of the spindle head 620 and the gripper unit 610 rotates so that the third hand and the first finished surface of the workpiece face the upper spindle. The spindle head 620 then moves toward the gripper unit 610 along the z axis so that a chuck of the upper spindle engages the first finished surface of the workpiece, as shown in FIG. 29. The spindle head 620 then withdraws from the gripper unit 610 along the z axis and moves along the x axis into a position where the second surface of the workpiece can be subjected to lathe and machine processing, as shown in FIG. 30. When processing is completed, the spindle head 620 moves into position aligned with the gripper unit 610 and the gripper unit 610 rotates so that a fourth hand configured to engage the second finished surface of the workpiece is facing the spindle head 620. The spindle head 620 then moves along the z axis towards the gripper unit 610 so that the fourth hand can engage the finished second surface of the workpiece, as shown in FIG. 31. The spindle head 620 is withdrawn and a conveyor or other moving device may then be moved into position to receive the finished workpiece from the fourth hand of the gripper unit 610. For example, the gripper unit 610 may rotate so that the finished workpiece is facing downward and the gripper unit 610 lowered by the y motion plate 631 of tool post 632 so that it can place the workpiece on a conveyor for removal.

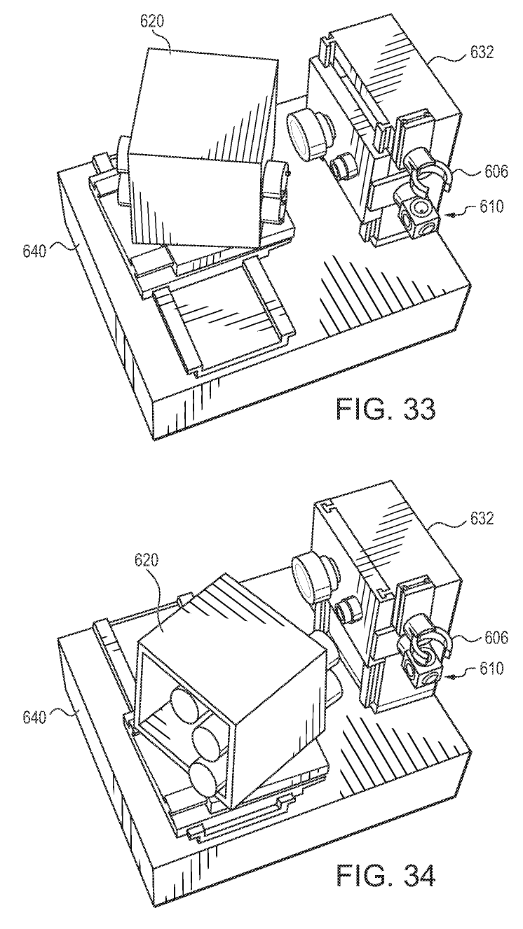

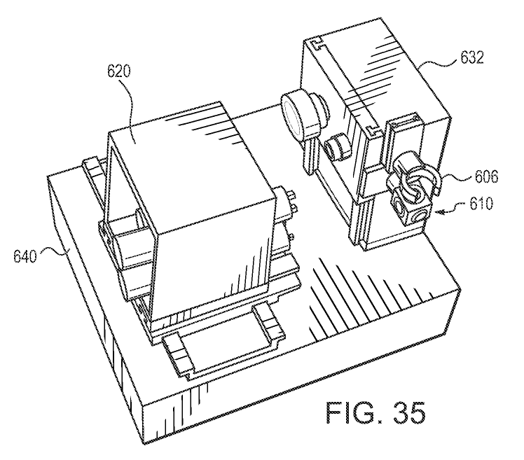

FIGS. 32 through 35 further illustrate computer controlled b axis rotational movement of an embodiment of a machine tool. In this embodiment, spindle head 620 provides computer controlled b axis rotational movement, such as through plate 646 shown in FIG. 19. FIG. 32 is a perspective view of a machine tool having a spindle head 620 with two spindles oriented vertically with respect to one another and machine base 640, where the spindle head 620 has computer controlled x, z and b axis motion. Note that other embodiments can provide for x, z and b axis motion in tool post 632. Tool post 632 is shown with a turret unit for lathing operations, a milling unit for machining operations, and a four hand rotating gripper unit 610 mounted together with computer controlled y axis motion provided by y motion plate 631 of tool post 632. A rotating reversing hand 606 is provided that is mounted to the tool post 632 with a fixed position. In terms of engaging the workpiece, this embodiment operates similarly to the embodiment of FIGS. 19 through 21 and 23 through 31 discussed above. This machine tool embodiment provides for b axis rotation, as illustrated in FIG. 33, which illustrates an example of an angled milling cut performed on the lower spindle, and FIG. 34, which illustrates an example of an angled milling cut performed on the upper spindle. As noted above, the machine tool can be provided be b axis rotation in the tool post 632 without departing from the scope of the invention. And the spindle head has x and z axis motion sufficient for the spindle head 620 and gripper unit 610 to cooperate in moving the workpiece at various stages of processing.

Certain embodiments can provide for use of a single spindle head. Whereas vibration has previously caused many systems to utilize multiple spindle heads, the present configuration mounts multiple spindles in a single spindle head. For this and other reasons, the footprint of the disclosed system may be significantly smaller, which requires less floor space.

All references, including publications, patent applications, and patents, cited herein are hereby incorporated by reference to the same extent as if each reference were individually and specifically indicated to be incorporated by reference and were set forth in its entirety herein. The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. Furthermore, the axes named and the directional language disclosed herein is intended to be exemplary, and not limiting as to the embodiments disclosed. For example, directional language such as “upward” and “downward” or axial descriptions such as “along the x axis” or similar are meant to be exemplary, but not limiting to only the disclosed directions. Further, the embodiments described above generally engage a workpiece in order to produce a partially or completely finished workpiece, but the workpiece is not to be construed as a limitation on the scope of the invention.

Preferred embodiments of this invention are described herein, including the best mode known to the inventors for carrying out the invention. It should be understood that the illustrated embodiments are exemplary only, and should not be taken as limiting the scope of the invention.

1. A computer controlled lathe, the lathe comprising:
a machine base;
a spindle head mounted on the machine base and having a first spindle configured to rotate on a first rotational axis and a second spindle configured to rotate on a second rotational axis, where the first and second rotational axes are parallel to one another and the first rotational axis is substantially vertical to the second rotational axis respective to the tool base, and each of the first and second spindles has a gripping hand for securely engaging a workpiece;
a first tool post mounted on the machine base and having a first rotatable tool turret configured to hold at least one cutting tool for use in cutting the workpiece while it is rotated by the first spindle; and
a second tool post mounted on the machine base and having a second rotatable tool turret configured to hold at least one cutting tool for use in cutting the workpiece while it is rotated by the second spindle;
where the spindle head, the first tool post, and the second tool post are mounted to provide computer controlled motion along a z axis that is parallel to the first and second rotational axes and computer controlled motion along an x axis that is substantially perpendicular to the first and second rotational axis.

2. The lathe of claim 1, wherein the spindle body is movably mounted to the machine base to provide the computer controlled motion along the z axis.

3. The lathe of claim 2, wherein the first and second tool posts are movably mounted to the machine base to provide the computer controlled motion along the x axis.

4. A computer controlled machine tool, the tool comprising:
a machine base;
a spindle head mounted on the tool base and having a first spindle configured to rotate on a first rotational axis and a second spindle configured to rotate on a second rotational axis, where the first and second rotational axes are parallel to one another and the first rotational axis is substantially vertical to the second rotational axis respective to the tool base, and each of the first and second spindles has a gripping hand for securely engaging a workpiece;
a tool post mounted on the machine base and having a rotatable tool turret configured to hold at least one cutting tool for use in cutting the workpiece while it is rotated by at least one of the first and second spindles;
where the spindle head and the tool post are mounted to provide computer controlled motion along a z axis that is parallel to the first and second rotational axes, computer controlled motion along an x axis that is substantially perpendicular to the first and second rotational axis; and
where the tool post is configured to provide computer controlled motion along a y axis that is perpendicular to the first and second rotational axes and the x axis.

5. The machine of claim 4, wherein the spindle body is movably mounted to the tool base to provide the computer controlled motion along the x and z axes.

6. The machine of claim 5, where the tool post includes a machining tool.

7. The machine of claim 6, where the spindle head and the tool post are mounted to provide computer controlled rotational motion around a b axis that is perpendicular to the first and second rotational axes and permits the machining to engage the workpiece at oblique angles.

8. The machine of claim 6, where the spindle body is rotatably mounted to provide the computer controlled rotational motion around the b axis.

9. The machine of claim 6, where the tool post includes a rotating gripper unit having multiple hands, where the rotating gripper unit is computer controlled.

11. A multiple spindle computer controlled machine tool for working a workpiece, the multiple spindle machine tool comprising:
first spindle means for engaging the workpiece and rotating the workpiece in a first rotational axis;
second spindle means for engaging the workpiece and rotating the workpiece in a second rotational axis;
spindle support means for mounting the first and second spindle means to a tool base;
tool supporting means having at least one tool for processing the workpiece while it is rotating by one of the first and second spindle means; and
where at least one of the spindle support means and tool supporting means is configured to provide computer controlled motion along a z axis that is parallel to the first and second rotational axes, along an x axis that is substantially perpendicular to the first and second rotational axes, and along a y axis that is perpendicular to the first and second rotational axes and the x axis.

12. The multiple spindle machine tool of claim 11, where the tool supporting means further includes a rotating tool means for selectively presenting a plurality of cutting tools for processing the workpiece.

13. The multiple spindle machine tool of claim 11, where the tool supporting means further includes milling means for milling the workpiece while the workpiece is engaged by at least one of the first and second spindle means.

14. The multiple spindle machine tool of claim 13, where at least one of the spindle support means and tool supporting means is further configured to provide computer controlled rotational motion around a b axis that is perpendicular to the first and second rotational axes and parallel to the y axis.

15. The multiple spindle machine tool of claim 11, where the tool supporting means further includes rotating gripping means for engaging the workpiece in the first and second spindle means under computer control.

16. The multiple spindle machine tool of claim 15, where the tool supporting means further includes reversing means for reversing an orientation of the workpiece with respect to the rotating gripping means.

17. The multiple spindle machine tool of claim 11, where the spindle support means motor means for rotating the first and second spindle means.
